(19) United States
(12) Patent Application Publication
(10) Pub. No.: US 2019/0057615 A1
(43) Pub. Date: Feb. 21, 2019

(54) METHODS AND SYSTEMS FOR MONITORING AND TREATING INDIVIDUALS WITH SENSORY PROCESSING CONDITIONS

(71) Applicant: Brian Mullen, Amherst, MA (US)

(72) Inventor: Brian Mullen, Amherst, MA (US)

(21) Appl. No.: 16/106,478

(22) Filed: Aug. 21, 2018

Related U.S. Application Data
(63) Continuation of application No. 14/775,026, filed on Sep. 11, 2015, now abandoned.
(60) Provisional application No. 61/782,096, filed on Mar. 14, 2013.

(51) Int. Cl. G09B 19/00; G09B 5/02

(52) U.S. Cl. CPC G09B 19/00; G09B 5/02; G09B 21/00

(57) ABSTRACT

Aspects of the invention relate to methods and systems for monitoring and treating individuals with sensory processing issues (e.g., individuals with autism). In some embodiments, methods involve measurement of environmental conditions (e.g., sound, light, location, time of day, air quality, odors, radiation, magnetic field strength, temperature, humidity, pollutants, etc.) that are sensory inputs affecting an individual's ability to perform tasks and behave in a desired way; implementing interventions based on the measured conditions to help the individual improve performance and behavior; monitoring the extent of improvement resulting from the interventions; and modifying the interventions based on the extent of improvement. Systems configured for carrying out the methods are also provided.

### RELATED APPLICATIONS

This application claims priority under 35 U.S.C. § 119(e) to U.S. Provisional Application Ser. No. 61/782,096, entitled “METHODS AND SYSTEMS FOR MONITORING AND TREATING INDIVIDUALS WITH SENSORY PROCESSING CONDITIONS,” filed on Mar. 14, 2014, which is herein incorporated by reference in its entirety.

### BACKGROUND OF INVENTION

Devices exist that employ sensors to monitor various parameters. Mobile apps and websites are available to log such parameters.

### SUMMARY OF INVENTION

Aspects of the invention relate to personal environmental measuring and monitoring solutions, and related applications. Further aspects of the invention relate to methods of determining environmental inputs/stimulus/characteristics (e.g., light brightness, light frequency, sound amplitude, sound frequency, pitch, tone, magnetic fields, aromas, radiation, pheromones, location, humidity, temperature, pollutants, air quality, altitude, etc.) experienced by an individual or group of individuals in the past or in real-time or to be experienced (e.g., before entering an environment).

In some embodiments, methods are provided that involve monitoring, recording and/or communicating data representative of the environment being experienced by an individual at any given moment. In some embodiments, an intervention is adjusted by relating the environmental characteristics to the individual's physiological response behavior, performance, predetermined/preselected characteristics of the environmental inputs or other information from self-reports, scales, tests, tasks, profiles, or physical and mental health measures (sensory profiles, age, weight, height, etc.).

In some embodiments, measurement of the extent of improvement resulting from the intervention is performed. In some embodiments, methods are provided that involve modifying the intervention based on the extent of improvement. In some embodiments, methods are provided that involve determining an initial individual profile of baseline individual characteristics such as age, physiological baselines, sex, sensory profiles or sensory response tendencies, or other mental and physiological information; monitoring a plurality of data elements representative of an environment which an individual is experiencing or an environment an individual may experience (e.g., using sensor on a desk in an office to assess whether the person could function in that environment); and recording selected ones of the plurality of data elements when said ones are determined to have a relationship to the individual's ability to perform, function, behave or influence the individual's emotional state.

In some embodiments, methods are provided that involve comparing the local or micro environmental measures to macro environmental conditions using geography location and available databases describing macro environmental conditions including but not limited to weather databases, satellite data, topology databases, geological databases, seismic activity, etc. In some embodiments, methods are provided that involve consolidating said selected ones for identifying a negative or positive impact on the individual's ability to function, preform, behave or negatively influence the individual's emotional state. In some embodiments, methods are provided that involve producing a report of the characteristics of the environment experience by an individual or maybe experienced by the individual for a period of time. In some embodiments, methods are provided that involve producing an intervention or recommendations for the individual to optimize their ability to perform, function, behavior or emotional experience in the environments they have, will or want to experience. In some embodiments, methods are provided that involve producing an output signal such as an electrical, mechanical or chemical output that can be used to start, end or control an intervention or device (such as lowering the lights in a room or starting an app or program on a smartphone or computer).

In some embodiments, methods are provided that involve comparing environmental experience to identify improvements either independent of other information (e.g., increased time in a previously intolerable environment) or in conjunction with non-environmental interventions such as physiology, self-reports, surveys, scales, profiles, tests, perceived conditions (e.g., behavior, function or performance measured by motion (accelerometer), sound (voice) or video monitoring) or functional and performance outcomes (e.g., more productive at work, observer reports from friends, family, colleagues or care providers). In some embodiments, methods are provided that involve creating interventions or taking action based on the environmental conditions and characteristics the individual has experienced, is, or will be experiencing in the future or in some combination of past, present and predicted or measured future environmental conditions the individual has been, is or will be exposed to. In some embodiments, methods are provided that involve modifying or adjusting current intervention or actions or modify interventions to prepare the individual for future environments they will or may experience.

In some embodiments, methods are provided that involve consolidating said selected data for identifying a negative or positive impact on the individual's ability to function, preform, behave or negatively influence the individual's emotional state. In some embodiments, methods are provided that involve consolidating said selected data for identifying a negative or positive impact of the intervention's or treatment's impact on the individual or group of individual's ability to function, preform, behave or negatively influence the individual's/group's emotional state. In some embodiments, methods are provided that involve producing a report of the characteristics of the environment experience by an individual or may be experienced by the individual. In some embodiments, methods are provided that involve sharing the data, analysis, reports between devices, platforms, people, etc. In some embodiments, said recording comprises identifying a trigger event associated with one of the data elements having the preselected relationship and recording both the one data element and trigger information representative of the trigger event.

In some embodiments, methods are provided that involve communicating (e.g., immediately communicating) to a central control station via an uplink information representative of a trigger event associated with one of the data elements. In some embodiments, methods are provided that involve recording trigger event response information generated by said control station. In some embodiments, methods are provided that involve generating derived data elements from said data elements. In some embodiments, said consolidating comprises accumulating said calculated and derived data elements.

In some embodiments, said monitoring comprises: calculating relevant features of the different measures such as time, amplitude, frequency, amount, type, volume, mass, etc., the individual or group was, is, or will be exposed to in the environmental conditions or characteristic and classifying relative portions of the exposure time amongst a plurality of rating classifications comprising such as high, medium, low, great, good, and poor or other classification technique of the environmental conditions impact on an individual's or group's function, performance, emotions and behavior; identifying geographic locations of the environmental conditions and classifying the identified geographic location for area of environmental conditions amongst a plurality of classifications comprising high, medium, and low or great, good, and poor environments for either function, performance, behavior, or emotions; identifying types of environments or environmental conditions and classifying the identified environments, environmental conditions or environmental characteristics, amongst a plurality of classifications comprising high, medium, and low or great, good, and poor environments for either function, performance, behavior, or emotions; and/or using the identifying types of biological, physiological, mental, emotional, behavioral, sensory and social traits and responses related to environments or environmental conditions and classifying the identified environments, environmental conditions or environmental characteristics, amongst a plurality of classifications comprising high, medium, and low or great, good, and poor environments for the different types of biological, physiological, mental, emotional, behavioral, sensory, and social traits and responses.

In some embodiments, said consolidating comprises calculation of an environmental impact score using a weighted average or sum of the different classifications for each measure based on a preselected weights. In some embodiments, the weighing and scoring is based on one or more of: the individual's profile information or historical responses to the given environments; the individual's self-rating; a care provider's based on observation, experience, or clinical techniques; and aggregated weights used by a population of people with similar profiles. In some embodiments, scores can be adjusted and modified over time or in real-time by the individual, care provider, or based on a mathematical algorithm such as the use of machine learning techniques, or system identification techniques.

In some embodiments, at least a portion of the data elements are within an awareness and selected control of the individual. In some embodiments, the method further comprises adjusting by the individual or group of the environmental conditions or characteristics thereby causing a change in the data elements to execute an intervention. In some embodiments, an element of control is selected from leaving the given environment, changing location in the current space, changing lighting, using ear plugs, or changing the sensory inputs such as listening to music via headphones, wearing sunglasses, etc.

In some embodiments, the base intervention is for a predetermined period of time and wherein the adjusting by the individual or care provider is set to occur at predetermined intervals within the predetermined period. In some embodiments, the predetermined period of time can be modified based on algorithms that compares the environmental conditions, individual profile, and metrics of benefits in real time or over a period of time which identifies and alerts the need for adjusting the intervention. In some embodiments, the need for an adjustment is triggered by: improvement in function, performance, behavior, emotional state; regression in function, performance, behavior, emotional state; and/or change in environmental conditions or characteristics.

Further aspects of the invention provide methods for acquiring and recording environmental related data during a time period via an on-board computer and recording system for adjusting interventions for individuals with sensory processing issues, neurological disorders, mental illnesses, and developmental disorders. In some embodiments, methods are provided that involve steps of monitoring a plurality of data elements representative of environmental states and individual actions or responses during the time period; recording selected ones of the data elements in an environment record file of an on-board data storage device when said ones are identified as having a relationship material to determination of the environmental conditions an individual is exposed to; identifying whether said selected ones comprise a trigger event, and if so identified, communicating information representative of the trigger event to a central control station for storage in a trigger event file; and consolidating said environmental record file and said trigger event file in a form for determining an intervention for the time period.

In some embodiments, methods are provided that involve communicating from the central control station an alert or warning to the individual or a care provider in response to the identifying of a special trigger event determined to require assistance.

In some embodiments, monitoring comprises: calculating relevant features of the different measures such as time, amplitude, frequency, amount, type, volume, mass, etc., the individual or group was, is, or will be exposed to in the environmental conditions or characteristic and classifying relative portions of the exposure time amongst a plurality of rating classifications comprising such as high, medium, low, great, good, and poor or other classification technique of the environmental conditions impact on an individual's or group's function, performance, emotions and behavior. In some embodiments, methods are provided that involve identifying geographic locations of the environmental conditions and classifying the identified geographic location for area of environmental conditions amongst a plurality of classifications comprising high, medium, and low or great, good, and poor environments for either function, performance, behavior, or emotions.

In some embodiments, methods are provided that involve identifying types of environments or environmental conditions and classifying the identified environments, environmental conditions or environmental characteristics, amongst a plurality of classifications comprising high, medium, and low or great, good, and poor environments for either function, performance, behavior, or emotions.

In some embodiments, methods are provided that involve using the identifying types of biological, physiological, mental, emotional, behavioral, sensory and social traits and responses related to environments or environmental conditions and classifying the identified environments, environmental conditions or environmental characteristics, amongst a plurality of classifications comprising high, medium, and low or great, good, and poor environments for the different types of biological, physiological, mental, emotional, behavioral, sensory, and social traits and responses. In some embodiments, consolidating comprises calculation of the different measures and classifications.

Further aspects of the invention provide systems for determining an intervention for a selected time period based upon monitoring, recording and communicating data representative of operator and vehicle driving characteristics. In some embodiments, the intervention is adjustable by relating the environmental conditions and characteristics to predetermined to an individual's response such as tests, scores, profiles, physiological responses, perceived conditions, behaviors, performance criteria, functional criteria, observations, self-reports or medical and mental states. In some embodiments, the system comprises means for predetermining an individual profile and a base intervention based on said profile; means for monitoring a plurality of data elements representative of an environment or an action or response to the environment by the individual during the selected time period; means for recording selected ones of the plurality of data elements when said ones are determined to have a preselected relationship to the individual's response; and/or means for consolidating said selected ones for identifying a change in intervention from the base intervention.

In some embodiments, the system further includes means for immediately communicating to a central control station via an uplink information representative of a trigger event associated with the data elements whereby a warning or alert may be selectively sent to a care provider or individual. In some embodiments, the system further includes means for generating calculated data elements. In some embodiments, the system further includes means for generating derived data elements. In some embodiments, the system further includes means for monitoring. In some embodiments, monitoring comprises calculating relevant features of the different measures such as time, amplitude, frequency, amount, type, volume, mass, etc., the individual or group was, is, or will be exposed to in the environmental conditions or characteristic and classifying relative portions of the exposure time amongst a plurality of rating classifications comprising such as high, medium, low, great, good, and poor or other classification technique of the environmental conditions impact on an individual's or group's function, performance, emotions and behavior. In some embodiments, monitoring comprises identifying geographic locations of the environmental conditions and classifying the identified geographic location for area of environmental conditions amongst a plurality of classifications comprising high, medium, and low or great, good, and poor environments for either function, performance, behavior, or emotions.

In some embodiments, monitoring comprises identifying types of environments or environmental conditions and classifying the identified environments, environmental conditions or environmental characteristics, amongst a plurality of classifications comprising high, medium, and low or great, good, and poor environments for either function, performance, behavior, or emotions.

In some embodiments, monitoring comprises using the identifying types of biological, physiological, mental, emotional, behavioral, sensory and social traits and responses related to environments or environmental conditions and classifying the identified environments, environmental conditions or environmental characteristics, amongst a plurality of classifications comprising high, medium, and low or great, good, and poor environments for the different types of biological, physiological, mental, emotional, behavioral, sensory, and social traits and responses. In some embodiments, said means for consolidating comprises said means for calculating a percentage of drive time in the drive time classifications and the drive location classifications.

Still further aspects of the invention relate to a method of generating an intervention class system for determining interventions for individuals and adjusting intervention types for a period of time. In some embodiments, the individuals have sensory issues, mental illness, neurological disorders, developmental disorders and medical conditions influenced by environmental conditions and characteristics experienced by an individual. In some embodiments, intervention types are adjusted for a period of time based on data derived from environmental conditions and characteristics, and/or an individual's profile, biology, physiology, mental health, medical health and response to the environmental conditions during said insurance period of time. In some embodiments, methods are provided that involve monitoring a plurality of data elements representing environmental conditions and individual response during said period of time; recording selected ones of the data elements in an environmental record file when said ones are identified as having a relationship material to determination of intervention; setting a plurality of intervention classes associated with corresponding degrees of responses to environmental conditions experienced by an individual; and/or consolidating said environmental record files with selected intervention classes for determining a corresponding intervention for the individual in correspondence with one of the intervention classes for the treatment period of time. In some embodiments, said monitoring and recording steps occur continuously and concurrently with actual environmental conditions for acquiring the data elements during actual exposure to an environment.

In some embodiments, said monitoring and recording steps occur prospectively based on actual environmental conditions for acquiring the data elements before actual exposure to an environment. In some embodiments, at least a portion of the plurality of data elements are within an awareness and selective control of the individual, the process further comprising adjusting by the individual or care provider of the environmental conditions to change said portion of data elements for matching said vehicle record with another one of the actuarial classes.

Still further aspects of the invention relate to an integrated system for extracting data from multiple sensors, and screening, aggregating and applying the data for intervention purposes. In some embodiment, the data are generated by an actual exposure to environmental conditions of a specific individual during a selected data collection period. In some embodiments, the integrated system comprises means for extracting a plurality of data elements from the multiple sensors wherein the elements are representative of environmental conditions states and individual's response and actions during the selected data collection period; means for screening the data elements and aggregating selected ones of the data elements in a device collecting environmental measures of an on-board storage device when said selected ones are identified as having a relationship material to determination of intervention for the individual; means for associating the aggregated selected data elements with predetermined intervention classes indicative of a degree of intervention needed by an individual based on their profile; and/or means for producing an intervention for the selected data collection period.

In some embodiments, the integrated system further comprises means for generating calculated data elements and derived data elements, said calculated and derived data elements being further aggregated for association with the intervention classes.

Other aspects of the invention relate to methods of generating a sensory class system for determining sensory profile for people with sensory issues, mental illness, neurological disorders, developmental disorders and medical conditions influenced by environmental conditions and characteristics experienced by an individual adjusting intervention types for a period of time based on data derived from environmental conditions and characteristics, and an individual's profile, biology, physiology, mental health, medical health and response to the environmental conditions during said insurance period of time. In some embodiments methods are provided that involve monitoring a plurality of data elements representing environmental conditions and individual response during said period of time; recording selected ones of the data elements in a senor module record file when said ones are identified as having a relationship material to determination of a sensory profile; setting a plurality of sensory classes associated with corresponding degrees of responses to environmental conditions of individuals; and/or consolidating said environmental record files with selected sensory classes for determining a corresponding intervention for the individual in correspondence with one of the sensory classes for the treatment period of time.

In some embodiments, said monitoring and recording steps occur continuously and concurrently with actual environmental conditions for acquiring the data elements during actual exposure to an environment. In some embodiments, said monitoring and recording steps occur prospectively based on actual environmental conditions for acquiring the data elements before actual exposure to an environment.

Still other aspects of the invention relate to methods for monitoring and treating individuals with sensory processing issues (e.g., individuals with autism). In some embodiments, methods are provided that involve measuring of environmental conditions (e.g., sound, light, location, time of day, air quality, odors, radiation, magnetic field strength, temperature, humidity, pollutants, etc.) that are sensory inputs affecting an individual's ability to function, perform and behave; implementing interventions to help the individual improve functional, performance and behavior based on the measured conditions; monitoring the extent of improvement resulting from the interventions; modifying the intervention based on the extent of improvement; and/or combining the environmental conditions with other data such as patient profiles, tests, scores, medical and mental health, and physiology or other perceivable conditions of the individual.

In some embodiments, methods are provided that involve combining information with environmental conditions to design, develop, implement, and adapt treatment and intervention in real-time, retrospectively, or prospectively.

### BRIEF DESCRIPTION OF DRAWINGS

FIG. 1 is a model of the world with environment being the input to a person and everything else a response; environment includes, for example, sensory information as well as air quality, or radiation; and

FIG. 2 is a Venn diagram depicting four components of personal performance, in which the greater the overlap in the components, the greater the person can perform.

FIG. 3 is a model of the components of an example system and their interactions

### DETAILED DESCRIPTION OF INVENTION

Provided herein are methods and systems for determining interventions for people with sensory processing issues or who want to improve/optimize their ability to perform under different environmental conditions. In some embodiments, the methods and systems are based upon monitoring, recording, analyzing, communicating, and tracking data representative of the environmental conditions and environmental characteristics experienced by an individual in real time, over a period of time and that the individual may encounter in the future. Interventions may be set by relating individual traits, characteristics, preferences, physical and mental states and obstacles/issues to predetermined individual goals, safety standards, treatment standards, standards of typical or healthy emotional, behavioral or functional abilities or other defined standards or goals set by an individual or care provider. Interventions may be designed, developed and implemented based on retrospective analysis of the environmental data and other related information, can be prospectively developed based on environmental conditions and characteristics and other related information for the individual to perform in environments to be entered, or interventions can be monitored and adapted based on the real time or future environmental conditions and characteristics experienced by the individual and tailored to the individual's specific functional, performance, behavioral and emotional needs in real time.

In some embodiments, method comprises steps of monitoring a plurality of raw data elements representative of the environmental conditions and characteristics experience or to be experienced by an individual. The raw data is recorded, the data is analyzed, and selected data elements or characteristics are identified. The selected data elements and characteristics are processed against the individual's profile to identify, design, monitor, and determine interventions that would be helpful to the individual to improve behavior, function, performance and emotional state given different and varying environmental conditions.

Aspects of the invention relate to a recognition that the body may be viewed as a system from and to which one can measure, monitor, and respond. In some embodiments, miniaturized sensors, mobile smartphones, and ability to constantly and continuously be connected to the internet are utilized. Aspects provide for the capability to collect data (monitor/measure) in real time in the real world, conduct real time analysis on that data and integrate it with other data transforming it into information and then share that information to result in an intervention/action in real time. In some embodiments, this capability is captured in useful medical devices. In some embodiments, devices for monitoring and collecting data are provided that help with health/medical conditions and performance for a healthy individual.

Aspects provided herein allow one to monitor physiology and behavior through a combination of sensors. One may monitor parameters such as heart rate, activity levels (accelerometer-fitbit), pulse, blood pressure, etc. in combination with method provided herein. Mobile apps and websites are provided to help people self-report their activities, behavior and nutritional intake. Systems provided herein, in some embodiments, help with exercise and dieting. Further embodiments provide physiology and behavioral journals to measure and monitor stress. Other embodiments involve blood sugar monitoring.

Aspects of the invention provide systems that capture output, action, and response data. Further aspects provide systems that capture environmental inputs. Such inputs are often impacting our mental and physical health and ability to perform. Aspects of the invention provide a system to measure, monitor, interpret, report, and create interventions based on inputs to our system from the environment to improve physical and mental health and performance.

Aspects of the invention are useful in an occupational therapy (OT) context for addressing sensory integration and sensory processing disorders. Methods and systems disclosed herein help provide health benefits to people with autism and mental illness through measuring, monitoring and tailoring interventions. The methods and systems are useful for monitoring and treating individuals with sensory processing disorders. Further aspects of the invention provide methods and systems for the personal performance market. Further aspects of the invention provide methods and systems for the industrial market to provide monitoring for employees. Information obtained using the systems and methods may be useful to environmental groups, government groups and others.

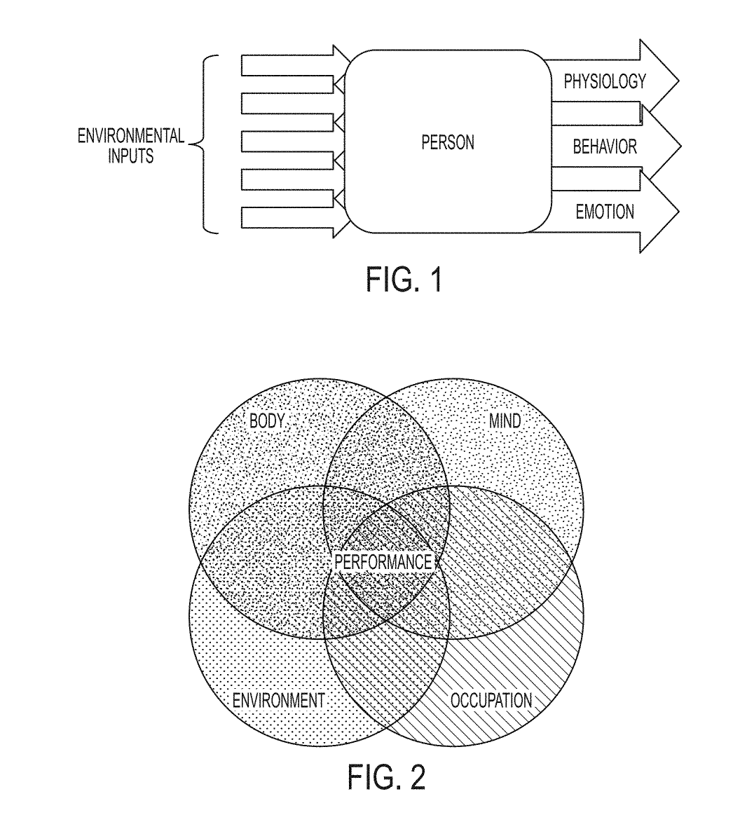

FIGS. 1 and 2 depict models based on Applicant's research in the OT field. This data is obtained because, combined with output data, it greatly enhances knowledge of a system/person.

Environment inputs include sensory inputs as well as health inputs like air quality, and physical environment (e.g., terrain, buildings, etc.). In some embodiments, the systems and methods do not utilize sensory inputs from the physical environment.

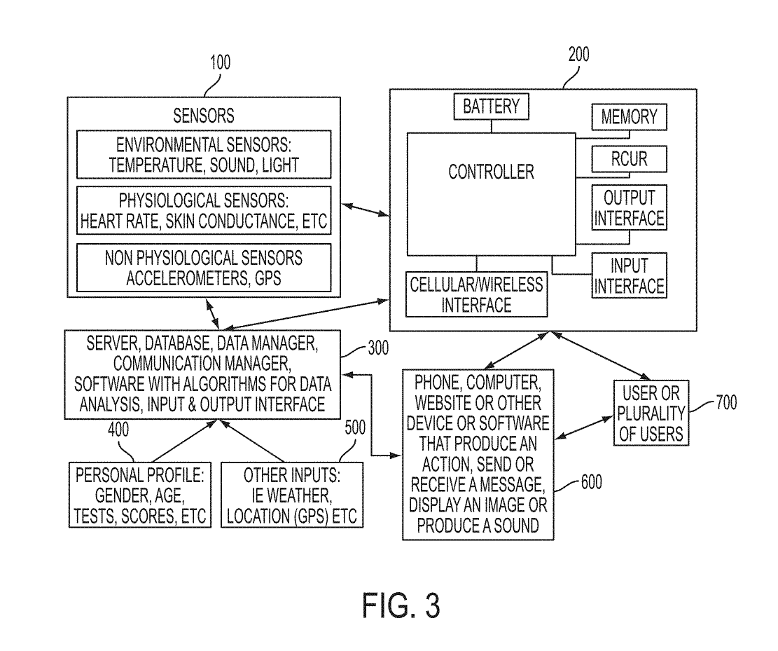

Referring now to FIG. 3, as an example, environmental conditions are measured by a set of sensors 100 such as the frequency of sounds and brightness of light. The sensor data is sent to a controller 200. The controller 200 may contain, for example, memory, processers, software, and input and output interfaces. The controller 200 may collect, aggregate, store, analyze, synchronize, communicate and transfer data and information which may be done on board independent of server 300, in parallel and conjunction with server 300, or by control of server 300. The sensors data can also be sent directly to the server 300 wirelessly. The server 300 may contain but is not limited to, memory, processers, software, and input and output interfaces. The server 300 collects, aggregates, stores, analyzes, communicates and transfers data and information. The server may receive information from many different types of sensors 300, and many different types of data, including but not limited to physiological data, profile 400, or other data that is stored in other databases, has been already aggregated or in some other format such as weather data, geographical data, etc. The controller 200, sensors 100 and server 300 can send the data or other information such as messages, prompts, commands, to other devices such as, for example, a phone, tablet, computer, TV, to share the data, report the data, provide a warning or alert, to provide an intervention, suggest an intervention or start, stop or modify the functions of the device. The data and information can be shared with one or more people and different data, information or actions can be sent to different people. Communication, data transfer between all devices can be down wirelessly or other method such as via a direct USB connection, Bluetooth, etc.

Referring to FIG. 3, in one embodiment, a person with a sensory processing issue uses an app on a smartphone functioning as a controller 200. The app uses the phone's on board microphone, light sensor, and camera to measure sounds (e.g., frequency, amplitude, etc.) and light (e.g., frequency—color, brightness, variations—flickering, etc.)—sensors 100. The app may use the phone's wireless and internet ports to send the information to the server. The server analyzes all the data received from the phone as well as other possible data sources and analyzes the data. If a trigger event is detected, such as the environment becoming too bright or too loud, or a combination of above-threshold light and sounds, the server may send a message to the user providing them with information on how to handle the environmental conditions, and messages can be sent to different care providers or other individuals such as an alert to an occupational therapist, or a suggested intervention for a parent to try to address the possible problematic conditions. Further, reports or alerts may be sent to care providers or the person after a series of trigger events such as the number of incidence experiencing bad environmental conditions increased by a predefined percentage over a given time period. The server or controller could also send a signal to another device to start, stop, or change such as lowering the lights in the room or turning off the radio etc.

In another example a person has a sensory processing disorder. A team of care providers are working with the individual to help treat the individual including a parent, teacher, occupational therapist, and medical doctor, for example. The person creates an account, user profile, downloads an application to a mobile device such as a smartphone or tablet, and uses an optional sensor unit (e.g., a wearable sensor unit). The person uses the app to collect environmental conditions either in real time or between specific hours, for example the app may be used during the hours of 8am-6pm, while asleep, etc. The person's profile indicates sensitivity to sounds. The sensors on the phone collect sounds in the range of the onboard microphone, as well as light from the light sensor, location via GPS, motion via the accelerometer, and the phone can also measure magnetic fields. The wearable sensor measures temperature. The data is collected during predetermined and/or preprogrammed periods of time.

At the start no interventions are defined except for basic default safety alerts, such as, for example, if a decibel level (e.g., within the immediate environment of the individual) exceeds and unsafe range or frequency. If one of the sensors enters an unsafe range it triggers an event to alert the person via a preselected or default method such as a message on the phone via the app, text message, email, phone call, voice alarm, alarm etc. If an unsafe event occurs similar messages can be sent to preselect selected care providers. The messages to the person when a triggered event occurs may provide information or suggestions on how to respond to the unsafe condition. The person and care provider may be sent the same or different messages. The trigger event may also trigger additional action such as using the smartphone or device to act as a controller of another device e.g., start, stop or modify the function of another device such as turn down the volume of the TV and/or radio to a safe level if that is the source or component of causing the unsafe noise level. Each triggered event may be recorded, stored and consolidated in its own record.

In addition, to environmental sensors an individual may also wear a heart rate monitor and galvanic skin response sensors, thus combining both environmental and physiological measures. Via the app the person also marked times, events, locations which caused discomfort and made notes. At the end of the first day or other defined time period the individual and care providers are sent reports and access the web based account and review the data. All the data collected is analyzed using algorithms. The person and care providers can select different analysis, display, and reporting options including schedule report generation based on triggers or elapsed periods of time. In one example, an analysis may show from sound data and physiology data between, for example, 8-9 am and 3-4 pm, that the individual was exposed to the most noise and had the highest heart rate with the highest levels between 8:45-9 am and 3-3:15 pm. A teacher or caregiver may note that a behavior issue occurred during the 8-9 time period. The individual and care team may select to overlay the GPS data and the parent notes during the time period indicating the person was waiting for school to start and the start of first period and the transition out of school home. Based on such information an intervention may be created by an occupational therapist, for example, to allow the individual to enter school early and stay late and uploaded the information to the users profile.

Data may be collected for a week or other defined period of time creating a baseline. The care providers using the reporting features of the system to identify different environmental and sensory triggers, in conjunction with the location data, weather conditions, physiology data. Classifications may be developed based on the environmental conditions and characteristics such as but not limited to any environment with a decibel (Db) greater than a specific level is considered a bad environment for the person. Interventions may be developed based on the data such as the child's difficulty coping with thunderstorms and the feel of rain or other condition. During therapy an occupational therapist or other care giver may develop specific interventions to help address these issues. The analysis may identify specific types of light is related to the person having difficulty paying attention as well as others. Based on the data and individual's profile, recommendations can be suggested of interventions that worked for other people with similar sensory issues for the given environmental conditions. The data can be used to categorize environments that are good environments or bad environments for the individual or environmental conditions that relate to high performance or function and low performance or function. These categories can be refined over time with more data.

Thus, care providers may create tailored prompts or actions that are triggered based on the data and environmental category. If an environment is entered that is identified as a bad or difficult environment for that person because of the lights, sounds, temperature etc. it may trigger an action such as a prompt on the smartphone to be displayed, a message of some kind to be sent, an image to be displayed or sent or control of another device or feature is started, modified, or ended such as turning on soothing music. The prompt or action can be sent to the individual or care provider or some combination of people. Different prompts, actions, and messages can be sent to different people. The individual can be provided a message helping them take action, e.g., an image of a person putting in ear plugs. The parent can be sent a message suggesting a method to help the person cope such as to give the person a hug because in the past that has helped calm the person in a similar distressful event. An occupational therapist or other caregiver can be notified to come to a classroom or other location in which the individual is present. For example, a teacher can be notified and help remove the individual from the environment such as the cafeteria becoming too loud and before it becomes painful for the person the teacher can offer them to eat in another room.

Other prompts could help the individual execute interventions by describing interventions that would be helpful in the given environment to improve performance or function, suggestions to cope with the environment such as putting on sound canceling headphones or sunglasses, suggestions to modify or change the environment when possible such as dim the lights, open the shades of the windows, or turn off a computer tower to stop the noise of the fan. Based on the data the smartphone and other device (e.g., mobile device) can be used and controlled via an app or remotely over a wireless network to provide intervention such as to play a specific type of music on the smartphone phone or start to display soothing images or turn on, turn off or modify other devices within range to improve the environmental conditions for function, performance and behavior such as not allowing someone to turn on the TV if the Db level is over a certain amount or to control the brightness of the lights in the room or to activate a wearable technology that can stimulate the sensory system.

After a month or other period of time a care team or person may review the data set, reports and analysis comparing to evaluating if the interventions developed are helping. Metrics that can be used are but not limited to was there an increased time exposed to previously identified bad environments, or improved performance, function or behavior in environments defined as low functioning environments or if the physiological responses related with different environmental conditions or stimulus improved, or have there been a change in the tests scores, profiles or other ratings and scales. Based on the results interventions can be ended, modified, improved, refined. Furthermore, based on the improvements, lack of improvement, strengths and weaknesses of the person based on the data new goals can be set and new issues can be identified and defined to be addressed.

A new goal may be created because the person needs to change schools or engage in an new activity or be exposed to a new set of conditions, e.g., a new job. As a result of the sensory issues the occupational therapist or other caregiver first goes to the different schools and leaves behind either a smartphone or modular sensor or mobile device that can measure environmental conditions to assess the different environmental conditions the person might be exposed to or will be exposed to in the future. The environmental data is either wireless sent by the device directly to the server in real time or uploaded later. Analysis and reports are generated using the individual's profile that has been developed accounting for trends, test scores, sensory issues, etc., to determine if the new environment is great, good or bad or if it would result in high, medium or low function or performance for the person. The analysis of the prospective analysis can identify environmental issues that may be an issue based on the retrospective data and trends and recommend possible interventions that have worked for others or have worked with the individual in the past for similar or the same environmental conditions or characteristics. The care providers can then create a perspective intervention to work on specific skills, behaviors, environmental modifications or sensory challenges, to prepare the person to enter into the new school or environment with minimal disruption, pain, anxiety because of environmental conditions or sensory processing issues.

Furthermore the data collected during the preparation process can help track and monitor progress to identify when the person may be ready for the change of school or to enter the new environment. One way to track progress and preparedness is, for example, tracking tolerance or exposure time to specific environmental conditions or stimuli. Another example would be to create an environment that is similar to the environment the individual will be exposed to, use the sensors to verify that the conditions are similar, and track performance or function measures, or the need for intervention in that environment. Furthermore interventions, prompts and actions can be changed developed and tested before entering the new environment such as if in the old school a local train could be heard every day but at the new school the train is closer resulting it being louder, and the feeling of a vibration as it passes by. The data may be used to 1) measure the vibration of the environment using an accelerometer, 2) measure if the condition is accurately replicated in preparation, and 3) allow for different prompts and interventions to be tried and adapted in the clinic or home setting, for example.

An example of a process relating to a web or mobile device based system is provided as follows.
Person creates profile either online via webpage or via an app on phone.
   Profile includes user information such as age, gender, past medical history, past mental health history, past scores, tests, inventories, profiles, etc., the user is prompted to take inventories, profiles and tests to add to profile, and the user can upload data sets such as physiological measures, accelerometer data, etc.
   Profile also includes username, password, etc.
   Person can chose to invite, select, or allow access to one or plurality of other individuals such as teachers, parents, occupational therapist, medical doctors, etc.
   Care providers (including but not limited to teachers, occupational therapists, parents, medical doctors) can add to the person's profile entering information such as medical history, mental history, observations, notes, test scores, etc.
   The person or care provider can input issues, goals, and targets related to emotional, behavioral, functional and performance outcomes.
   Persons and care providers can see reports, analysis and raw data.
   Interventions are created, modified, tracked and stored online.
   Setting are created and adjusted.
Person downloads app for given device and/or buys a compatible sensor unit that can sense environmental conditions, store and share the data either directly to a smartphone or computer via a hard connection or wireless connections such as Bluetooth or cellular connection.
Person activates app. The app automatically detects available sensors on the smartphone, tablet or device. The person can use the settings in the app to deactivate or active specific sensors.
The app uses the on board hardware and software components that app sync, sends, receives, and communicates with the database. The app and remote database stay synced over an internet, wireless, cellular, etc. connection.
Either on the app or in the profile settings, data collection can be started or ended or a data collection schedule can be set, such as, for example, data collection within a certain period of time, e.g., 8 am-6 pm, or data collection while present at a certain location or after leaving a location or when between locations (e.g., while moving from one location to another location).
The app or database can also receive and send information, data, commands, etc. to other external devices such as phones, tables, computers, TV's, wearable technologies, etc.
Sensor units independent of a smartphone can collect, store, analysis and send data to the database or other devices wirelessly or other form.
The database or server collecting the data from the different devices analysis the data in real time to identify triggers which result in an action or prompt or message to be sent and then takes the right action.
The database aggregates the data and creates, refined, and identifies categories and classes based on the individual and environmental conditions using a mix of different algorithms.
The server can generate and share reports to different individuals based on predefined access settings.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above.

As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (e.g., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances.

Accordingly, the foregoing description and drawings are by way of example only.

1. A method of determining the environmental conditions experienced by an individual or group of individuals, the method comprising:
determining initial baseline characteristics of an individual, optionally wherein the baseline characteristics are selected from: age, physiological baselines, sex, sensory profiles or sensory response tendencies, and other mental and physiological information;
monitoring a plurality of data elements representative of a local environment which an individual is experiencing or an environment an individual is expected to experience;
recording selected ones of the plurality of local environment data elements when said ones are determined to have a relationship to the individual's ability to perform, function, behave or influence the individual's emotional state; and
comparing the local environmental data elements to one or more macro-environmental conditions using geographic location and/or an available database describing macro-environmental conditions, optionally wherein the database is selected from weather databases, satellite data, topology databases, geological databases, seismic activity, and other similar databases.

2. The method of claim 1, further comprising consolidating said selected ones for identifying a negative or positive impact on the individual's ability to function, preform, behave or negatively influence the individual's emotional state.

3. The method of claim 1, producing a report of the characteristics of the environment experience by an individual or maybe experienced by the individual for a period of time.

4. The method of claim 1, further comprising producing an intervention or recommendations for the individual to optimize their ability to perform, function, behavior or emotional experience in the environments they have, will or want to experience.

5. The method of claim 1, further comprising producing an output signal such as an electrical, mechanical or chemical output that can be used to start, end or control an intervention or device (e.g., lowering the lights in a room or starting an app or program on a smartphone or computer).

6. The method of claim 1, further comprising comparing environmental experience to identify improvements either independent of other information (e.g., increased time in a previously intolerable environment) or in conjunction with non-environmental interventions such as physiology, self-reports, surveys, scales, profiles, tests, perceived conditions (behavior, function or performance measured by motion (accelerometer), sound (voice) or video monitoring) or functional and performance outcomes (e.g., more productive at work, observer reports from friends, family, colleagues or care providers).

7. The method of claim 1, further comprising producing interventions or taking action based on the environmental conditions and characteristics the individual has experienced, is, or will be experiencing in the future or in some combination of past, present and predicted or measured future environmental conditions the individual has been, is or will be exposed to.

8. The method of claim 1, further comprising modifying or adjusting current intervention or actions or modify interventions to prepare the individual for future environments they will or may experience.

9. The method of claim 1, further comprising consolidating said selected data for identifying a negative or positive impact on the individual's ability to function, preform, behave or negatively influence the individual's emotional state;

10. The method of claim 1, further comprising consolidating said selected data for identifying a negative or positive impact of the interventions or treatment's impact on the individual or group of individual's ability to function, preform, behave or negatively influence the individual's/group's emotional state;

11. The method of claim 1, further comprising producing a report of the characteristics of the environment experience by an individual or maybe-experienced by the individual.

12. The method of claim 1, further comprising sharing the data, analysis, reports between devices, platforms, people etc.

13. The method of claim 1, wherein said recording comprises identifying a trigger event associated with a one of the data elements having the preselected relationship and recording both the one data element and trigger information representative of the trigger event.

14. The method of claim 1, further comprising immediately communicating to a central control station via an uplink information representative of a trigger event associated with a one of the data elements.

15. The method of claim 1, further comprising recording trigger event response information generated by said control station.

16. The method of claim 1, further comprising generating derived data elements from said data elements.

17. The method as described in claim 16 wherein said consolidating comprises accumulating said calculated and derived data elements.

18. The method of claim 1, wherein said monitoring comprises:
calculating relevant features of the different measures such as time, amplitude, frequency, amount, type, volume, mass, etc. the individual or group was, is, or will be exposed to in the environmental conditions or characteristic and classifying relative portions of the exposure time amongst a plurality of rating classifications comprising such as high, medium, low, great, good, and poor or other classification technique of the environmental conditions impact on an individual or group's function, performance, emotions and behavior; and
further identifying geographic locations of the environmental conditions and classifying the identified geographic location for area of environmental conditions amongst a plurality of classifications comprising high, medium, and low or great, good, and poor environments for either function, performance, behavior, or emotions; or
further identifying types of environments or environmental conditions and classifying the identified environments, environmental conditions or environmental characteristics, amongst a plurality of classifications comprising high, medium, and low or great, good, and poor environments for either function, performance, behavior, or emotions; or
further using the identifying types of biological, physiological, mental, emotional, behavioral, sensory and social traits and responses related to environments or environmental conditions and classifying the identified environments, environmental conditions or environmental characteristics, amongst a plurality of classifications comprising high, medium, and low or great, good, and poor environments for the different types of biological, physiological, mental, emotional, behavioral, sensory, and social traits and responses.

19. The method as described in claim 18 wherein said consolidating comprises calculation of an environmental impact score using a weighted average or sum of the different classifications for each measure based on a preselected weights wherein the weighing and scoring is based on one or more of:
the individual's profile information or historical responses to the given environments,
the individual's self-rating,
a care provider's based on observation, experience, or clinical techniques, and
aggregated weights used by a population of people with similar profiles.

20. The method of claim 19, wherein the scores can be adjusted and modified over time or in real-time by the individual, care provider, or based on a mathematical algorithm such as the use of machine learning techniques, or system identification techniques.

21. The method of claim 1, wherein at least a portion of the data elements are within an awareness and selected control of the individual and therein the method further comprises adjusting by an the individual or group of the environmental conditions or characteristics thereby causing a change in the data elements to execute an intervention.

22. The method as described in claim 21, wherein the base intervention is for a predetermined period of time and wherein the adjusting by the individual or care provider is set to occur at predetermined intervals within the predetermined period.

23. The method as described in claim 22, wherein the predetermined period of time can be modified based on algorithms that compares the environmental conditions, individual profile, and metrics of benefits in real time or over a period of time which identifies and alerts the need for adjusting the intervention wherein the need for and adjustment is triggered by improvement in function, performance, behavior, emotional state; or regression in function, performance, behavior, emotional state; or change in environmental conditions or characteristics

24-45. ( canceled)
